(19) United States
(12) Patent Application Publication
(10) Pub. No.: US 2009/0204602 A1
(43) Pub. Date: Aug. 13, 2009

(54) APPARATUS AND METHODS FOR PRESENTING LINKING ABSTRACTS FOR SEARCH RESULTS

(75) Inventor: Tamas Sarlos, Sunnyvale, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/030,765

(22) Filed: Feb. 13, 2008

(51) Int. Cl. G06F 17/30

(52) U.S. Cl. 707/5; 707/E17.014

(57) ABSTRACT

Disclosed are apparatus and methods for providing linking abstracts for a plurality of search results. In certain embodiments, an abstract of a listed search result is revised to include links to locations within the associated search result document that are proximate to one or more abstract portions. When the user selects a particular linkable abstract portion within a particular listed search result, the user is then provided with the corresponding location within the particular search result document. That is, the linked abstract portion is caused to be presented to the user.

### BACKGROUND OF THE INVENTION

The present invention is related to search services provided over a computer network. It especially pertains to providing abstracts for the search results that are generated from a search term query.

In recent years, the Internet has been a main source of information for millions of users. These users rely on the Internet to search for information of interest to them. One conventional way for users to search for information is to initiate a search query through a search service's web page. Typically, a user can enter one or more search term(s) into an input box on the search web page and then initiate a search based on such entered search term(s). In response to a query, a web search engine generally returns an ordered list of web documents.

FIG. 1 is a screen shot showing a portion of a search web page 100 in which a search query has been initiated for the search term “orange” 102 and a list of search results 104 have been presented based on such search term “orange” 102. As shown, each entry in the list of search results 104 includes a title (e.g., title 106a and 106b), a universal resource locator (URL) link (e.g., 110a and 110b), and an abstract (e.g., 108a and 108b). The abstract gives a concise summary to the user that indicates something about why the associated search result document is relevant for the particular query. The abstract is often constructed by extracting multiple sentences or sentence portions from the document, in which the search term(s) are emphasized or highlighted (e.g., boldface). After a user determines that a document may be relevant by reading the abstract, the user can then navigate to a particular search result document by selecting the title. Selection of the document's title will cause the document to be presented to the user, starting at the first page of such document.

For longer documents, especially if they cover multiple topics or if the query is very specific to a narrowly defined topic, the most relevant parts of the document may be located rather far down in the document and may not be immediately visible after the user selects the document title. After selecting a particular search result document by selecting the title, the user often finds that it is time consuming and difficult to locate the sentences that were used in the abstract.

Accordingly, it would be beneficial to provide improved mechanisms for presenting search results.

### SUMMARY OF THE INVENTION

Accordingly, apparatus and methods for providing linking abstracts for a plurality of search results are provided. In certain embodiments, an abstract of a listed search result is revised to include links to locations within the associated search result document that are proximate to one or more abstract portions. When the user selects a particular linkable abstract portion within a particular listed search result, the user is then provided with the corresponding location within the particular search result document. That is, the linked abstract portion is caused to be presented to the user.

In one embodiment, a method for providing search results to a user of a search service is disclosed. The following operations are performed for at least a portion of a plurality of ranked search result documents and their associated abstracts, which were obtained over a computer network by a search service based on one or more search terms of a search query from a user. Each document is searched for one or more linkable objects that are associated with a location within the each document that is most proximate to at least one portion of the each document's abstract. A list of search result documents is provided to the user, and this list includes a plurality of revised abstracts, wherein each revised abstract contains one or more selectable links to the one or more linkable objects that were found for at least one abstract portion of the associated document. Each link is associated with its corresponding abstract portion or abstract within the list search result documents such that the each link is selectable by the user to thereby cause the each link's associated document location and its proximate abstract portion or abstract to be automatically presented to the user.

In a specific implementation, when the user selects a particular link that is associated with a particular, corresponding abstract portion or abstract, the particular, corresponding abstract portion or abstract is provided to the user so that the link's associated document location is displayed to the user, wherein the displayed location is associated with the linkable object of the selected link. In another aspect, only documents that have a length that is longer than the user's expected screen size are searched for linkable objects so as to provide revised abstracts.

In yet another implementation, each linkable object is a tag or object that is associated with a specific location of a corresponding document that can be used to create a link to such specific document location. In another aspect, each linkable object is an HTML (HyperText Markup Language) tag of a corresponding document location to which a link can be formed.

In a further embodiment, a plurality of linkable object candidates are determined for each abstract portion or abstract. The linkable object candidates include a decision to not use a linkable object and the linkable object that is associated with the location within the each document that is most proximate to at least one abstract portion. A best candidate of the linkable object candidates is determined for each abstract portion or abstract. The revised abstracts utilize the best candidate as the link for such each abstract portion or abstract or provide no link if the best candidate is the decision to not use a linkable object. In another embodiment, at least one revised abstract's content is adjusted, in addition to providing the one or more selectable links, based on whether a selectable link was provided for each abstract portion of the adjusted revised abstract. In yet another embodiment, user search information regarding a plurality of users and their interactions with revised abstracts is collected. Content, other than links, of the obtained abstracts is then adjusted based on the collected user search information prior to providing the abstracts or the revised abstracts with their associated links to the user.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 is a screen shot showing a portion of a search web page in which a search query has been initiated and a list of search results have been presented based on such search query.

FIG. 2 is a flow chart illustrating a procedure for generation of linking abstracts in accordance with one embodiment of the present invention.

FIG. 3 is a flowchart illustrating a procedure for linking abstract feedback in accordance with a specific implementation of the present invention.

FIG. 4A illustrates an example list of ranked search results with revised linking abstracts in accordance with one embodiment of the present invention.

FIG. 4B illustrates a document and its linkable objects that correspond to the linkable abstract portions of a listed search result of FIG. 4A in accordance with an example implementation of the present invention.

FIG. 5 is a simplified diagram of a network environment in which specific embodiments of the present invention may be implemented.

FIG. 6 illustrates an example computer system in which specific embodiments of the present invention may be implemented.

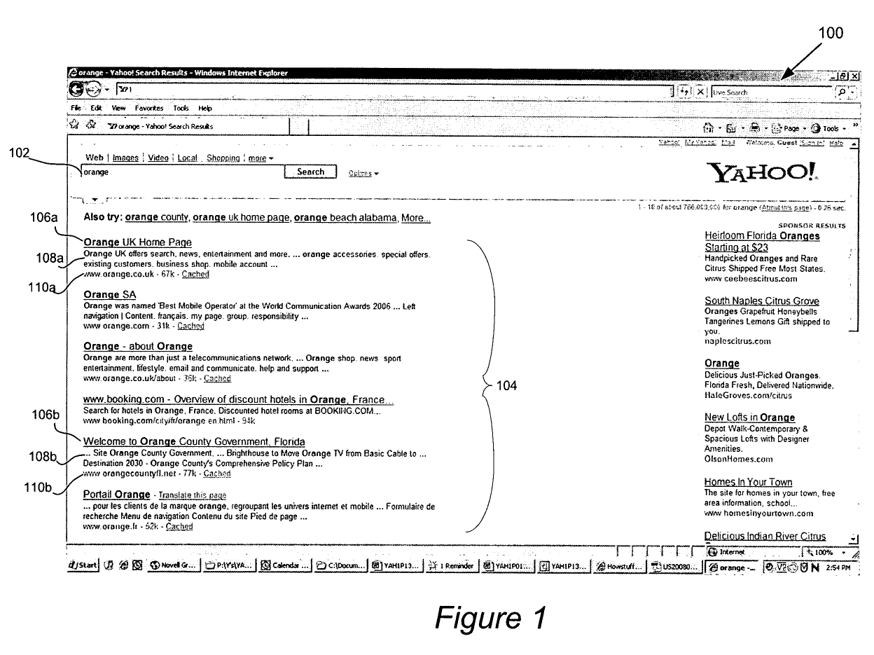

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, mechanisms for providing linking abstracts for search results are provided. In one embodiment, one or more abstract portions are associated with a link that is selectable, e.g., via clicking with a mouse, so that a user may automatically be jumped, via such link, to a document portion that contains a linkable object that is proximate to the associated abstract portion. In other words, the abstract contains links to relevant document portions. When a user clicks on an abstract link, her browser then automatically accesses the document portion that is proximate to the selected abstract portion. In a specific implementation, the document fragment addressing capabilities of the Uniform Resource Locator (URL) scheme are exploited to provide such linking abstracts.

It should also be noted that embodiments of the invention are contemplated in which the operation of the underlying search engine is largely unaffected by the overlying use of linking abstracts. That is, in response to a search query, the search engine may acquire information relating to the search query as it would conventionally, i.e., without the benefits of or reference to the abstract customizations enabled by the present invention. The customizations of the appropriate abstract portions are then applied to the conventionally retrieved results. However, embodiments are also contemplated in which the operation of the underlying search engine is altered in some way to enable at least some further customizations as described further below. For example, the ranking of the search results may be affected by the outcome of the revised abstracts or the abstract content that is retrieved by the search engine may be revised based on whether or not links can be associated with particular abstract portions as explained further below.

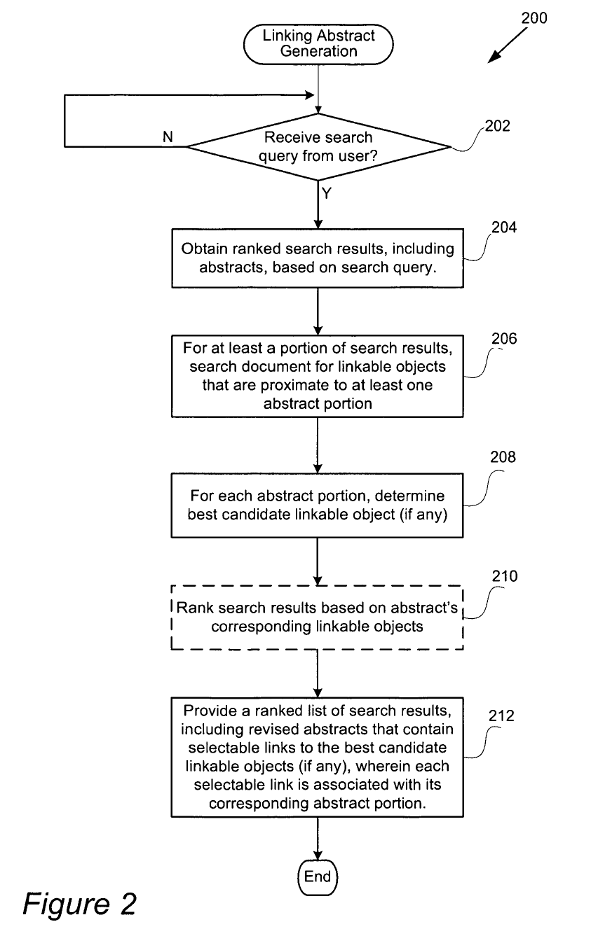

FIG. 2 is a flow chart illustrating a procedure 200 for generation of linking abstracts in accordance with one embodiment of the present invention. Initially, it its determined whether a search query has been received from a user in operation 202. A user may take any suitable form, such as a human or a software agent. If a search query has not been received, the procedure 200 may continue to wait for a search query in operation 202. After a search query is received, ranked search results, including abstracts, are obtained based on such search query in operation 204.

In general, a search engine may generate a query response by performing the following steps. First, one or more pre-created indexes or databases of Web pages or sites are searched using one or more search terms extracted from the query to generate a list of hits (e.g., target pages or sites, or references to target pages or sites, which contain the search terms or are otherwise identified as being relevant to the query). The indexes or databases are created and continuously updated by one or more web crawlers or by a document link registration process.

Web crawlers are automatic software agents that move from link to link to compile indexes of key words related to each document. For example, a web crawler may be configured to start with a well known web page and follow every link on such page, as well as the links of subsequent pages, etc. It is also contemplated that web searches may be performed without the use of indexes or web crawlers.

After the search engine compiles a list of hits from such indexes or databases, the hits are ranked according to predefined criteria, and the best results (according to these criteria) are given the most prominent placement, e.g., at the top of the list. Several ranking techniques are described further in U.S. patent application, having publication number 2008/0010281 A1, published 10 Jan. 2008, which application is incorporated herein by reference in its entirety for all purposes.

The search engine also generates an abstract for at least a portion of the search result documents (e.g., the top ranked results) based on one or more search terms. In general, the abstract will contain one or more sentences or sentence portions that contain one or more of the search terms from the search query. The search engine determines which sentences or sentence portions of a particular search result document are most relevant based on the number of search terms used in such sentence or sentence portion, the relative location of the sentences or sentence portions, etc.

For at least a portion of the search results, the document is searched for linkable objects that are proximate to at least one abstract portion in operation 206. A document may be selected for such a search and such selected document may then be searched for linkable objects based on any suitable criteria. By way of example, the following factors may be analyzed to determine which documents to search and to then find a list of potential linkable object candidates: the target document, including but not limited to its URL, title, length, Document Object Model (DOM) parse tree of the HTML (HyperText Markup Language) source, visual presentation including the physical and screen coordinates of page elements when the page is rendered, anchor text, presence of a table of contents, the query (e.g., number of results, query logs), and the combination of the query and the target document (e.g., the location of the query terms and phrases on the page or whether they are present in the URL or title), etc.

In one implementation, only the N top most relevant documents may be searched for linkable objects. In a specific embodiment, only the 10-20 top most relevant documents may be searched so as to efficiently generate abstracts for only the likely documents that will be viewed by the user in the list of search results. Additionally, if an abstract was not generated for a particular document, such document is not included in the search for linkable objects. Only documents that have a length that is longer than a predefined minimum length (e.g., longer than one page on the expected screen size of the user) may also be included in the linkable object search so as to provide a linking abstract since a user may find these documents to be difficult to navigate without linking abstracts.

A linkable object may include any tag or object that is associated with a specific location of a document that can be used to create a link to such specific document location. By way of example, a search result document that was created using the HTML protocol may contain link tags that can be used to provide links to specific document locations. One type of link tag “<a name=“theName”> Text or Image</a>” creates a target name to a portion of a page to which to link. The document typically contains another link tag “<a href=“#theName”> other Text or Image </a>” that creates a link to the target name. Typically, a document will contain links at the top of the document to a plurality of document locations that have specific target names. In a specific table of contents type example, the link tag “<a name=Section1>Text/Image</a>” has the target name “Section 1” and can be referenced with link “<a href=“#Section1”> Text/Image </a>” inside the document and as “<a href=“X#Section1”> Text/Image </a>” from other documents where X denotes URL of the target document. In this example, the target name “Section1” is referred to as a named anchor to which a link may be created. Other types of linkable objects may include other tags, such as <div>, <span>, <il>, and, <ul>, which have an id=“target name” attribute.

For each abstract portion of the searched set of documents, the best candidate linkable object may then be determined in operation 208. For instance, the search for linkable objects may have produced a plurality of candidates. Of course, the list of candidates always includes the candidate for not making the abstract portion clickable. Other candidates may be generated from externally addressable DOM nodes of the HTML tree, such as named anchors or other tags as specified above. The candidates may be described with their tree or visual distance from their most proximate abstract portion, overlap in the name/id attribute and the query terms, number of external references to this candidate, etc. In one implementation, a quantification or measurement of the proximity of a linkable object to its most proximate abstract portion may be determined in any suitable manner. In one example, the number of document lines or a percentage amount of document that are between an abstract portion and the preceding linkable object is determined as the proximity value for such linkable object. Vertical and horizontal screen distances between the abstract portion and the nearby linkable object, measured in pixels as well as inches, could also serve as a proximity value and multiple proximity measures could be applied simultaneously.

A ranking system for selecting the best candidate may be generating by learning a ranking or scoring rule (e.g., boosted regression trees, logistic regression, or a ranking support vector machine) over a human labeled set of query-document-abstract portion examples. The ranking system may also be improved by incorporating the feedback from the observed selection rates of abstracts links.

The search results may then be optionally ranked based on the abstracts' corresponding linkable objects in operation 210. For instance, search results that have linkable objects may be ranked ahead of search results that do not have linking abstracts.

The ranked list of search results, including revised abstracts that contain selectable links to the best candidate linkable objects (if any), is then provided so that each link is associated with its corresponding abstract portion in operation 212. Some search results may have a linking abstract, while other search results may have a unrevised abstract or no abstract. When the best candidate for a particular abstract portion has been determined to be no linkable object, the particular abstract portion is not associated with a link. However, when the best candidate for a particular abstract portion is a linkable object that is proximate to such abstract portion, a link is associated with such abstract portion within the presented abstract. For example, the abstract portion is highlighted or underlined to indicate that it is a selectable link. Alternatively, a popup window could appear when the user moves their cursor over such link so as to indicate that the user can jump to such abstract portion by selecting it.

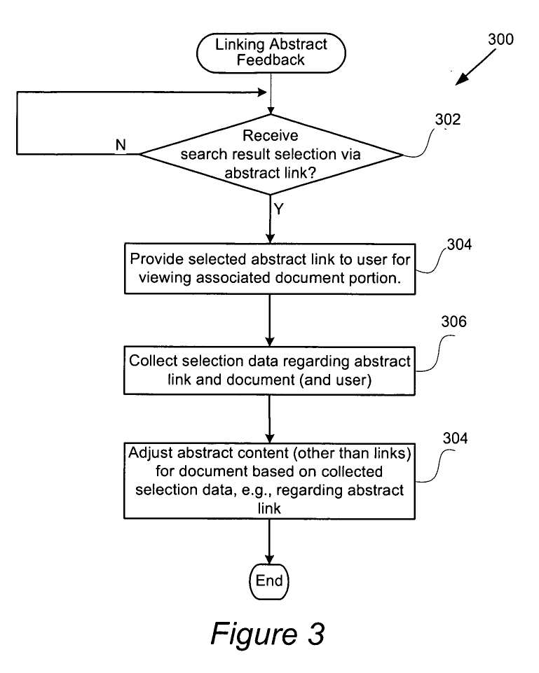

FIG. 3 is a flowchart illustrating a procedure 300 for linking abstract feedback in accordance with a specific implementation of the present invention. Initially, it is determined whether a search result selection has been received via an abstract link in operation 302. If such a selection has not been received, the procedure 300 waits in operation 202. After a search result selection is received via an abstract link, the selected abstract link may then be provided to the user for viewing the associated document portion in operation 304.

Selection data regarding the abstract link and document (and possibly the user) may also be collected in operation 306. For instance, well established link tracking methods such as redirect servers or insertion of link tracking Javascript code into the search result pages could be utilized to record the user clicks on the modified abstracts and unmodified titles. Furthermore, the user's browser may include a tool bar from the particular search service provider that collects information regarding user searches and sends such collected information back to the search provider for analysis with the user's knowledge and agreement. Such collected information may later be used by the search engine to make searching more efficient for the same user or for every user. In one example, an abstract's content, other than the links, for a particular document may also be adjusted based on the collective selection data, e.g., regarding the associated abstract link(s), in operation 304. That is, if one or more abstract links have been frequently clicked by a lot of users, the other infrequently selected abstract portions (linked or unlinked) may be removed from the abstract content.

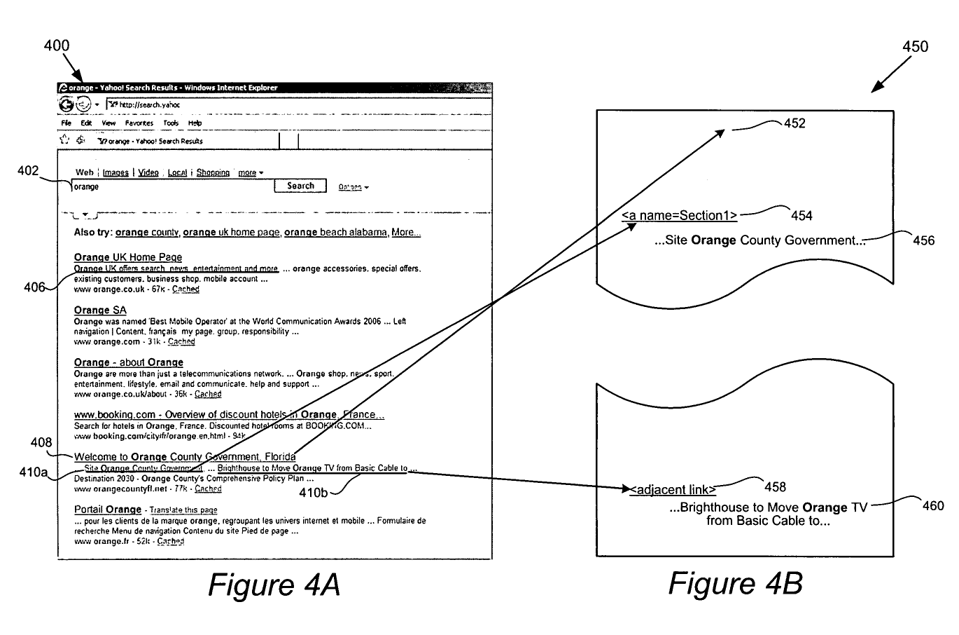

FIG. 4A is a screen shot 400 of an example list of ranked search results with revised linking abstracts in accordance with one embodiment of the present invention. These search results are based on the search term “orange” 402. As shown, some of the search results have a revised linking abstract. The first search result has an abstract with a linked abstract portion 406, while the fifth search result has two linked abstract portions 410a and 410b.

A link is associated with each linkable abstract portion such that a user can select such link. In this example, each linkable abstract portion and its link are represented by an underlining format although other formats can be used to associate a link with an abstract portion. When the user selects or clicks on a particular link or linkable abstract portion, the user is then provided with the corresponding location in the document. For example, the linkable object that is most proximate to the abstract portion is provided to the user.

FIG. 4B illustrates a document 450 and the linkable objects that correspond to the linkable abstract portions of the fifth listed search result of FIG. 4A in accordance with an example implementation of the present invention. Selection of a linkable abstract portion 410a or 410b of the fifth search result provides a user with a portion of the document that is proximate to the selected abstract portion. When the user selects or clicks on a link or linkable abstract portion 410a, the user is provided with the document location associated with the corresponding linkable object 454, i.e., “<a name=Section1>”. For instance, the user is provided with the document's URL, e.g., http://X appended with the fragment “#Section1” to form the page fragment (e.g., http://X#Section1) corresponding to the linkable object. Likewise, selection of the link 410b, provides the user with a page fragment that corresponds to the linkable object 458. In contrast, when the user selects the title 408, the user is provided with the top of the page, e.g., default location 452.

Embodiments of the present invention have several associated advantages. For example, the presentation of the link in the linkable abstract portion makes it clear to the user that the abstract portion is clickable. Additionally, linkable abstract portions enhance a user's browser experience by eliminating the need to manually relocate the piece of information on the target page that was already found by the search engine for the abstract. This efficiency may be especially beneficial when the document is very large, e.g., a FAQ, documentation, a long enumerative list, or encyclopedia entry.

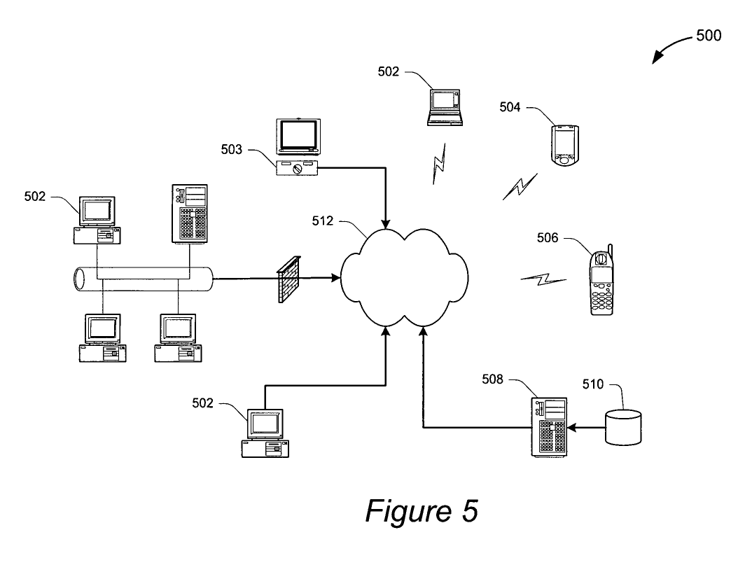

Embodiments of the present invention may be employed to generate linking abstracts or utilize such linking abstracts in any of a wide variety of computing contexts. For example, as illustrated in FIG. 5, implementations are contemplated in which the relevant population of users interact with a diverse network environment via any type of computer (e.g., desktop, laptop, tablet, etc.) 502, media computing platforms 503 (e.g., cable and satellite set top boxes and digital video recorders), handheld computing devices (e.g., PDAs) 504, cell phones 506, or any other type of computing or communication platform.

And according to various embodiments, search queries, search responses, and user feedback may be obtained using a wide variety of techniques. For example, search queries or link selections representing a user's interaction with a local application, web site or web-based application or service may be accomplished using any of a variety of well known mechanisms for recording and determining a user's behavior. However, it should be understood that such methods are merely exemplary and that such information may be collected in many other ways.

Once search results, including abstracts, (and possible other collected search information) have been obtained, this information may be analyzed and used to generate and utilize linking abstracts according to the invention in some centralized manner. This is represented in FIG. 5 by server 508 and data store 510 that, as will be understood, may correspond to multiple distributed devices and data stores. The invention may also be practiced in a wide variety of network environments (represented by network 512) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

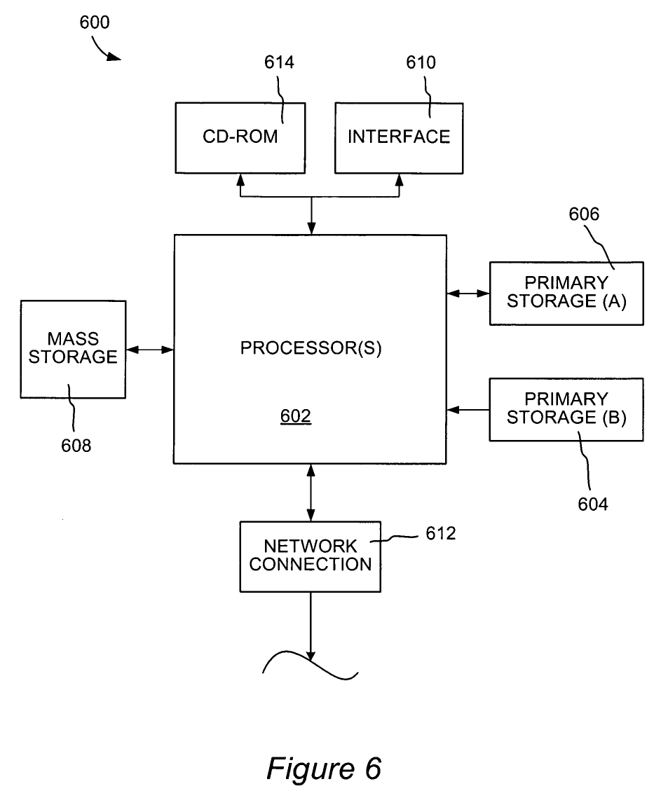

FIG. 6 illustrates a typical computer system that, when appropriately configured or designed, can serve as a search engine, linking abstract generator, etc. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers and microprocessors such as programmable devices (e.g., CPLDs and FPGAs) and unprogrammable devices such as gate array ASICs or general-purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described herein. A mass storage device 608 is also coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications network using an external connection as shown generally at 612. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store user behavior information, user category and education scores, query information, query results information, ranked search results, abstracts, revised linking abstracts, user link selection information, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for providing search results to a user of a search service, comprising:
for at least a portion of a plurality of ranked search result documents and their associated abstracts, which were obtained over a computer network by a search service based on one or more search terms of a search query from a user, searching each document for one or more linkable objects that are associated with a location within the each document that is most proximate to at least one portion of the each document's abstract; and
providing a list of search result documents to the user so that the list includes a plurality of revised abstracts, wherein each revised abstract contains one or more selectable links to the one or more linkable objects that were found for at least one abstract portion of the associated document, wherein each link is associated with its corresponding abstract portion or abstract within the list search result documents such that the each link is selectable by the user to thereby cause the each link's associated document location and its proximate abstract portion or abstract to be automatically presented to the user.

2. The method as recited in claim 1, further comprising when the user selects a particular link that is associated with a particular, corresponding abstract portion or abstract, providing the particular, corresponding abstract portion or abstract to the user so that the link's associated document location is displayed to the user, wherein the displayed location is associated with the linkable object of the selected link.

3. The method as recited in claim 1, wherein only documents that have a length that is longer than the user's estimated screen size are searched for linkable objects so as to provide revised abstracts.

4. The method as recited in claim 1, wherein each linkable object is a tag or object that is associated with a specific location of a corresponding document that can be used to create a link to such specific document location.

5. The method as recited in claim 1, wherein each linkable object is an HTML (HyperText Markup Language) tag of a corresponding document location to which a link can be formed.

6. The method as recited in claim 1, further comprising:
determining a plurality of linkable object candidates for each abstract portion or abstract, wherein the linkable object candidates include a decision to not use a linkable object and the linkable object that is associated with the location within the each document that is most proximate to at least one abstract portion; and
determining a best candidate of the linkable object candidates for each abstract portion or abstract, wherein the revised abstracts utilize the best candidate as the link for such each abstract portion or abstract or provide no link if the best candidate is the decision to not use a linkable object.

7. The method as recited in claim 1, further comprising adjusting at least one revised abstract's content, in addition to providing the one or more selectable links, based on whether a selectable link was provided for each abstract portion of the adjusted revised abstract.

8. The method as recited in claim 1, further comprising:
collecting user search information regarding a plurality of users and their interactions with revised abstracts; and
adjusting content, other than links, of the obtained abstracts based on the collected user search information prior to providing the abstracts or the revised abstracts with their associated links to the user.

9. An apparatus comprising at least a processor and a memory, wherein the processor and/or memory are configured to perform the following operations:
for at least a portion of a plurality of ranked search result documents and their associated abstracts, which were obtained over a computer network by a search service based on one or more search terms of a search query from a user, searching each document for one or more linkable objects that are associated with a location within the each document that is most proximate to at least one portion of the each document's abstract; and
providing a list of search result documents to the user so that the list includes a plurality of revised abstracts, wherein each revised abstract contains one or more selectable links to the one or more linkable objects that were found for at least one abstract portion of the associated document, wherein each link is associated with its corresponding abstract portion or abstract within the list search result documents such that the each link is selectable by the user to thereby cause the each link's associated document location and its proximate abstract portion or abstract to be automatically presented to the user.

10. The apparatus as recited in claim 9, wherein the processor and/or memory are further configured to perform the following operation: when the user selects a particular link that is associated with a particular, corresponding abstract portion or abstract, providing the particular, corresponding abstract portion or abstract to the user so that the link's associated document location is displayed to the user, wherein the displayed location is associated with the linkable object of the selected link.

11. The apparatus as recited in claim 9, wherein only documents that have a length that is longer than the user's estimated screen size are searched for linkable objects so as to provide revised abstracts.

12. The apparatus as recited in claim 9, wherein each linkable object is a tag or object that is associated with a specific location of a corresponding document that can be used to create a link to such specific document location.

13. The apparatus as recited in claim 9, wherein each linkable object is an HTML (HyperText Markup Language) tag of a corresponding document location to which a link can be formed.

14. The apparatus as recited in claim 9, wherein the processor and/or memory are further configured to perform the following operations:
determining a plurality of linkable object candidates for each abstract portion or abstract, wherein the linkable object candidates include a decision to not use a linkable object and the linkable object that is associated with the location within the each document that is most proximate to at least one abstract portion; and
determining a best candidate of the linkable object candidates for each abstract portion or abstract, wherein the revised abstracts utilize the best candidate as the link for such each abstract portion or abstract or provide no link if the best candidate is the decision to not use a linkable object.

15. The apparatus as recited in claim 9, wherein the processor and/or memory are further configured to adjust at least one revised abstract's content, in addition to providing the one or more selectable links, based on whether a selectable link was provided for each abstract portion of the adjusted revised abstract.

16. The apparatus as recited in claim 9, wherein the processor and/or memory are further configured to perform the following operations:
collecting user search information regarding a plurality of users and their interactions with revised abstracts; and
adjusting content, other than links, of the obtained abstracts based on the collected user search information prior to providing the abstracts or the revised abstracts with their associated links to the user.

17. At least one computer readable storage medium having computer program instructions stored thereon that are arranged to perform the following operations:
for at least a portion of a plurality of ranked search result documents and their associated abstracts, which were obtained over a computer network by a search service based on one or more search terms of a search query from a user, searching each document for one or more linkable objects that are associated with a location within the each document that is most proximate to at least one portion of the each document's abstract; and
providing a list of search result documents to the user so that the list includes a plurality of revised abstracts, wherein each revised abstract contains one or more selectable links to the one or more linkable objects that were found for at least one abstract portion of the associated document, wherein each link is associated with its corresponding abstract portion or abstract within the list search result documents such that the each link is selectable by the user to thereby cause the each link's associated document location and its proximate abstract portion or abstract to be automatically presented to the user.

18. The at least one computer readable storage medium as recited in claim 17, wherein the computer program instructions are further arranged to perform the following operation: when the user selects a particular link that is associated with a particular, corresponding abstract portion or abstract, providing the particular, corresponding abstract portion or abstract to the user so that the link's associated document location is displayed to the user, wherein the displayed location is associated with the linkable object of the selected link.

19. The at least one computer readable storage medium as recited in claim 17, wherein only documents that have a length that is longer than the user's estimated screen size are searched for linkable objects so as to provide revised abstracts.

20. The at least one computer readable storage medium as recited in claim 17, wherein each linkable object is a tag or object that is associated with a specific location of a corresponding document that can be used to create a link to such specific document location.

21. The at least one computer readable storage medium as recited in claim 17, wherein each linkable object is an HTML (HyperText Markup Language) tag of a corresponding document location to which a link can be formed.

22. The at least one computer readable storage medium as recited in claim 17, wherein the computer program instructions are further arranged to perform the following operations:
determining a plurality of linkable object candidates for each abstract portion or abstract, wherein the linkable object candidates include a decision to not use a linkable object and the linkable object that is associated with the location within the each document that is most proximate to at least one abstract portion; and
determining a best candidate of the linkable object candidates for each abstract portion or abstract, wherein the revised abstracts utilize the best candidate as the link for such each abstract portion or abstract or provide no link if the best candidate is the decision to not use a linkable object.

23. The at least one computer readable storage medium as recited in claim 17, wherein the computer program instructions are further arranged to adjust at least one revised abstract's content, in addition to providing the one or more selectable links, based on whether a selectable link was provided for each abstract portion of the adjusted revised abstract.

24. The at least one computer readable storage medium as recited in claim 17, wherein the computer program instructions are further arranged to perform the following operations:
collecting user search information regarding a plurality of users and their interactions with revised abstracts; and
adjusting content, other than links, of the obtained abstracts based on the collected user search information prior to providing the abstracts or the revised abstracts with their associated links to the user.
